(19) United States
(12) Patent Application Publication
(10) Pub. No.: US 2021/0216854 A1
(43) Pub. Date: Jul. 15, 2021

(54) NEURAL NETWORK SEARCHING METHOD, DEVICE AND STORAGE MEDIUM

(71) Applicant: BEIJING SENSETIME TECHNOLOGY DEVELOPMENT CO., LTD., Beijing (CN)

(72) Inventors: Xinchi ZHOU, Beijing (CN); Dongzhan Zhou, Beijing (CN); Shuai Yi, Beijing (CN); Wanli Ouyang, Beijing (CN)

(21) Appl. No.: 17/214,197

(22) Filed: Mar. 26, 2021

Related U.S. Application Data
(63) Continuation of application No. PCT/CN2019/116623, filed on Nov. 8, 2019.

(30) Foreign Application Priority Data
May 31, 2019 (CN) 201910471323.1

(51) Int. Cl. G06N 3/04; G06N 3/08; G06N 3/063; G06K 9/62

(52) U.S. Cl. CPC G06N 3/0454; G06N 3/08; G06K 9/6256; G06K 9/6262; G06N 3/063

(57) ABSTRACT

The disclosure relates to a neural network searching method and device. The method comprises: acquiring a neural network library to be searched and a training data set; sorting neural networks with a number of trained cycles of a first preset value in the neural network library to be searched according to a descending order of recognition accuracy on the training data set to obtain a first neural network sequence set, and taking first M neural networks in the first neural network sequence set as a first neural network set to be trained; performing first-stage training on the first neural network set to be trained by using the training data set, wherein the number of training cycles of the first-stage training is a second preset value; and taking a neural network with a number of trained cycles of the sum of the first preset value and the second preset value in the neural network library to be searched as a target neural network. A corresponding device is also disclosed. According to the technical solutions of the disclosure, computing resources and time spent on neural network search can be reduced.

The present application is a continuation of and claims priority under 35 U.S.C. 120 to PCT Application No. PCT/CN2019/116623, filed on Nov. 8, 2019, which claims priority to Chinese Patent Application No. 201910471323.1, filed with the Chinese National Intellectual Property Administration (CNIPA) on May 31, 2019 and entitled “Neural Network Searching Method and Device”. All the above-referenced priority documents are incorporated herein by reference.

### TECHNICAL FIELD

The disclosure relates to the technical field of image processing, in particular to a neural network searching method and device.

### BACKGROUND

Neural networks are widely used in the field of computer vision. The performance of neural networks is related to their structures. How to determine the structure of a neural network with good performance is very important.

### SUMMARY

The disclosure provides a technical solution about neural network search.

In a first aspect, there is provided a neural network searching method, wherein the method comprises: acquiring a neural network library to be searched and a training data set; sorting neural networks with a number of trained cycles of a first preset value in the neural network library to be searched according to a descending order of recognition accuracy on the training data set to obtain a first neural network sequence set, and taking first M neural networks in the first neural network sequence set as a first neural network set to be trained; performing first-stage training on the first neural network set to be trained by using the training data set, wherein the number of training cycles of the first-stage training is a second preset value; and taking a neural network with a number of trained cycles of the sum of the first preset value and the second preset value in the neural network library to be searched as a target neural network.

In a first aspect, by performing first-stage training on a first neural network to be trained, neural networks in a neural network library to be searched are trained by stages, that is, only neural networks with good performance from a previous stage of training enter a next training stage, thus reducing computing resources and time spent on neural networks with poor performance from a previous stage of training, so as to reduce computing resources and time spent on the search process.

In a possible implementation, before sorting neural networks with a number of trained cycles of a first preset value in the neural network library to be searched according to a descending order of recognition accuracy on the training data set to obtain a first neural network sequence set and taking first M neural networks in the first neural network sequence set as a first neural network set to be trained, the method further comprises: sorting neural networks with a number of trained cycles of a third preset value in the neural network library to be searched according to the descending order of recognition accuracy on the training data set to obtain a second neural network sequence set, and taking first N neural networks in the second neural network sequence set as a second neural network set to be trained; and performing second-stage training on the second neural network set to be trained by using the training data set, wherein the sum of the number of training cycles of the second-stage training and the third preset value is equal to the first preset value.

In such a possible implementation, firstly, neural networks of a number of trained cycles being a third preset value in the neural network library to be searched are sorted according to recognition accuracy, and then first N neural networks after sorting are subjected to second-stage training. According to the above implementation, staged training is performed on the neural networks in the neural network library to be searched, that is, only neural networks with high recognition accuracy after being trained in the previous stage enter the next training stage, but neural networks with low recognition accuracy after being trained in the previous stage do not enter the next training stage, thus reducing the computing resources consumed by neural network search and shortening the search time.

In another possible implementation, before sorting neural networks with a number of trained cycles of a third preset value in the neural network library to be searched according to the descending order of recognition accuracy on the training data set to obtain a second neural network sequence set and taking first N neural networks in the second neural network sequence set as a second neural network set to be trained, the method further comprises: adding R evolved neural networks to the neural network library to be searched, wherein the evolved neural networks are obtained by evolving the neural networks in the neural network library to be searched; and sorting neural networks with a number of trained cycles of a third preset value in the neural network library to be searched according to the descending order of recognition accuracy on the training data set to obtain a second neural network sequence set and taking first N neural networks in the second neural network sequence set as a second neural network set to be trained, includes: sorting neural networks with a number of trained cycles of the third preset value in the neural network library to be searched and the R evolved neural networks according to the descending order of recognition accuracy on the training data set to obtain a third neural network sequence set, and taking the first N neural networks in the third neural network sequence set as the second neural network set to be trained.

In such a possible implementation, by adding evolved neural networks to the neural network library to be searched, the search effect is improved, that is, the probability of obtaining a neural network with good performance through search is improved.

In another possible implementation, after performing first-stage training on the first neural network set to be trained by using the training data set, the method further comprises executing X iterations, the iterations including: adding S evolved neural networks to the neural network library to be searched, wherein the evolved neural networks are obtained by evolving the neural networks in the neural network library to be searched, and S is equal to R; sorting neural networks with a number of trained cycles of the third preset value in the neural network library to be searched and the S evolved neural networks according to the descending order of recognition accuracy on the training data set to obtain a fourth neural network sequence set, and taking the first N neural networks in the fourth neural network sequence set as a third neural network set to be trained; sorting neural networks with a number of trained cycles of the first preset value in the neural network library to be searched according to the descending order of recognition accuracy on the training data set to obtain a fifth neural network sequence set, and taking first M neural networks in the fifth neural network sequence set as a fourth neural network set to be trained; performing the second-stage training on the third neural network set to be trained by using the training data set, and performing the first-stage training on the fourth neural network set to be trained by using the training data set; and the method further comprises removing neural networks which have not been trained in T iterations from the neural network library to be searched, where T is less than X.

In such a possible implementation, by removing neural networks which have not been trained in T iterations from the neural network library to be searched in the iterative process of search, the spent on computing resources in neural network search is reduced, and the search speed is increased.

In another possible implementation, adding R evolved neural networks to the neural network library to be searched includes: duplicating R neural networks in the neural network library to be searched to obtain R duplicated neural networks; evolving the R duplicated neural networks by modifying structures of the R duplicated neural networks to obtain R neural networks to be trained; performing third-stage training on the R neural networks to be trained by using the training data set to obtain the R evolved neural networks, wherein the number of training cycles of the third-stage training is the third preset value; and adding the R evolved neural networks to the neural network library to be searched.

In such a possible implementation, the evolved neural networks are obtained by adjusting structures of the neural networks in the neural network library to be searched, which can enrich the structures of the neural networks in the neural network library to be searched and improve the search effect.

In another possible implementation, the neural networks in the neural network library to be searched are used for image classification.

In conjunction with the first aspect and any of the foregoing possible implementations, in a possible implementation, the neural networks in the neural network library to be searched can all be used for image classification.

In another possible implementation, the neural network in the neural network library to be searched includes a normal cell, a reduction cell and a classification cell; the normal cell, the reduction cell and the classification cell are sequentially connected in series; the normal cell is used for extracting a feature from image input into the normal cell; the reduction cell is used for extracting a feature from image input into the reduction cell and reducing size of the image input into the reduction cell; the classification cell is used for obtaining a classification result of the image input into the neural networks of the neural network library to be searched according to the feature output by the reduction cell; each of the normal cell and the reduction cell includes a plurality of neural cells; neural cells in the plurality of neural cells are sequentially connected in series, and input of an (i+1)-th neural cell includes output of an i-th neural cell and output of an (i−1)-th neural cell; the (i+1)th neural cell, the i-th neural cell and the (i−1)-th neural cell belong to the plurality of neural cells, where i is a positive integer greater than 1; a neural cell includes j nodes; input of a k-th node is output of any two of the k−1 nodes before the k-th node, where k is a positive integer greater than 2, and k is less than or equal to j; output of the neural cell is resulted from a concat of output of a j-th node and output of a (j−1)-th node; the node includes at least two operations; input of the operation is the input of the node; and the operation is any one of convolution, pooling and mapping.

In such a possible implementation, a structure of the neural networks in the neural network library to be searched is provided, and neural networks with various structures can be obtained based on the structure to enrich the structures of the neural networks in the neural network library to be searched.

In another possible implementation, modifying structures of the R duplicated neural networks includes: modifying the structures of the R duplicated neural networks by changing input to neural cells of the R duplicated neural networks; and/or modifying the structures of the R duplicated neural networks by changing operations in nodes of the neural cells of the R duplicated neural networks.

In such a possible implementation, structures of duplicated neural networks are modified by changing input to neural cells of the duplicated neural networks and/or operations in nodes of the neural cells of the duplicated neural networks, so as to realize the evolution of the duplicated neural networks.

In another possible implementation, acquiring a neural network library to be searched includes: acquiring neural networks to be searched; and performing the third-stage training on the neural networks to be searched by using the training data set to obtain the neural network library to be searched, wherein the neural network library to be searched contains the neural networks to be searched been subjected to the third-stage training.

In such a possible implementation, the neural network library to be searched is obtained by performing the third-stage training on the neural networks to be searched, so that neural network search can be performed based on the neural network library to be searched later.

In another possible implementation, taking a neural network with a number of trained cycles of the sum of the first preset value and the second preset value in the neural network library to be searched as a target neural network includes: sorting neural networks with a number of trained cycles of the sum of the first preset value and the second preset value in the neural network library to be searched according to the descending order of recognition accuracy on the training data set to obtain a fifth neural network sequence set, and taking first Y neural networks in the fifth neural network sequence set as the target neural networks.

In such a possible implementation, Y neural networks with the highest recognition accuracy among the neural networks with a number of trained cycles of the sum of a first preset value and a second preset value are taken as target neural networks to further improve the search effect.

In a second aspect, there is provided a neural network searching device, wherein the device comprises: an acquiring unit, for acquiring a neural network library to be searched and a training data set; a sorting unit, for sorting neural networks with a number of trained cycles of a first preset value in the neural network library to be searched according to a descending order of recognition accuracy on the training data set to obtain a first neural network sequence set, and taking first M neural networks in the first neural network sequence set as a first neural network set to be trained; a training unit, for performing first-stage training on the first neural network set to be trained by using the training data set, wherein the number of training cycles of the first-stage training is a second preset value; and a determining unit, for taking a neural network with a number of trained cycles of the sum of the first preset value and the second preset value in the neural network library to be searched as a target neural network.

In another possible implementation, the sorting unit is further configured to: before sorting neural networks with a number of trained cycles of a first preset value in the neural network library to be searched according to a descending order of recognition accuracy on the training data set to obtain a first neural network sequence set and taking first M neural networks in the first neural network sequence set as a first neural network set to be trained, sort neural networks with a number of trained cycles of a third preset value in the neural network library to be searched according to the descending order of recognition accuracy on the training data set to obtain a second neural network sequence set, and taking first N neural networks in the second neural network sequence set as a second neural network set to be trained; and the training unit is further configured to perform second-stage training on the second neural network set to be trained by using the training data set, wherein the sum of the number of training cycles of the second-stage training and the third preset value is equal to the first preset value.

In another possible implementation, the neural network searching device further comprises a neural network evolution unit configured to: before sorting neural networks with a number of trained cycles of a third preset value in the neural network library to be searched according to the descending order of recognition accuracy on the training data set to obtain a second neural network sequence set and taking first N neural networks in the second neural network sequence set as a second neural network set to be trained, add R evolved neural networks to the neural network library to be searched, wherein the evolved neural networks are obtained by evolving the neural networks in the neural network library to be searched; and the sorting unit is in particular configured to sort neural networks with a number of trained cycles of the third preset value in the neural network library to be searched and the R evolved neural networks according to the descending order of recognition accuracy on the training data set to obtain a third neural network sequence set, and taking the first N neural networks in the third neural network sequence set as the second neural network set to be trained.

In another possible implementation, the neural network searching device further comprises an execution unit configured to: after performing first-stage training on the first neural network set to be trained by using the training data set, execute X iterations, the iterations including: adding S evolved neural networks to the neural network library to be searched, wherein the evolved neural networks are obtained by evolving the neural networks in the neural network library to be searched, and S is equal to R; sorting neural networks with a number of trained cycles of the third preset value in the neural network library to be searched and the S evolved neural networks according to the descending order of recognition accuracy on the training data set to obtain a fourth neural network sequence set, and taking the first N neural networks in the fourth neural network sequence set as a third neural network set to be trained; sorting neural networks with a number of trained cycles of the first preset value in the neural network library to be searched according to the descending order of recognition accuracy on the training data set to obtain a fifth neural network sequence set, and taking first M neural networks in the fifth neural network sequence set as a fourth neural network set to be trained; performing the second-stage training on the third neural network set to be trained by using the training data set, and performing the first-stage training on the fourth neural network set to be trained by using the training data set; and the neural network searching device further comprises a removing unit for removing neural networks which have not been trained in T iterations from the neural network library to be searched, where T is less than X.

In another possible implementation, the neural network evolution unit is in particular configured to: duplicate R neural networks in the neural network library to be searched to obtain R duplicated neural networks; evolve the R duplicated neural networks by modifying structures of the R duplicated neural networks to obtain R neural networks to be trained; perform third-stage training on the R neural networks to be trained by using the training data set to obtain the R evolved neural networks, wherein the number of training cycles of the third-stage training is the third preset value; and add the R evolved neural networks to the neural network library to be searched.

In another possible implementation, the neural networks in the neural network library to be searched are used for image classification.

In another possible implementation, the neural network in the neural network library to be searched includes a normal cell, a reduction cell and a classification cell; the normal cell, the reduction cell and the classification cell are sequentially connected in series; the normal cell is used for extracting a feature from image input into the normal cell; the reduction cell is used for extracting a feature from image input into the reduction cell and reducing size of the image input into the reduction cell; the classification cell is used for obtaining a classification result of the image input into the neural networks of the neural network library to be searched according to the feature output by the reduction cell; each of the normal cell and the reduction cell includes a plurality of neural cells; neural cells in the plurality of neural cells are sequentially connected in series, and input of an (i+1)-th neural cell includes output of an i-th neural cell and output of an (i−1)-th neural cell; the (i+1)th neural cell, the i-th neural cell and the (i−1)-th neural cell belong to the plurality of neural cells, where i is a positive integer greater than 1; a neural cell includes j nodes; input of a k-th node is output of any two of the k−1 nodes before the k-th node, where k is a positive integer greater than 2, and k is less than or equal to j; output of the neural cell is resulted from a concat of output of a j-th node and output of a (j−1)-th node; the node includes at least two operations; input of the operation is the input of the node; and the operation is any one of convolution, pooling and mapping.

In another possible implementation, the neural network evolution unit is in particular configured to: modify the structures of the R duplicated neural networks by changing input to neural cells of the R duplicated neural networks; and/or modify the structures of the R duplicated neural networks by changing operations in nodes of the neural cells of the R duplicated neural networks.

In another possible implementation, the acquiring unit is in particular configured to: acquire neural networks to be searched; and perform the third-stage training on the neural networks to be searched by using the training data set to obtain the neural network library to be searched, wherein the neural network library to be searched contains the neural networks to be searched been subjected to the third-stage training.

In another possible implementation, the determining unit is in particular configured to: sort neural networks with a number of trained cycles of the sum of the first preset value and the second preset value in the neural network library to be searched according to the descending order of recognition accuracy on the training data set to obtain a fifth neural network sequence set, and take first Y neural networks in the fifth neural network sequence set as the target neural networks.

In a third aspect, there is provided a processor, wherein the processor is used for executing the method according to the first aspect and any possible implementation thereof.

In a fourth aspect, there is provided an electronic apparatus, comprising a processor, a transmitting device, an input device, an output device and a memory, the memory being used for storing computer program codes, and the computer program codes comprising computer instructions which, when executed by the processor, cause the electronic apparatus to execute the method according to the first aspect and any possible implementation thereof.

In a fifth aspect, there is provided a computer readable storage medium storing a computer program, and the computer program includes program instructions which, when executed by a processor of an electronic apparatus, cause the processor to execute the method according to the first aspect and any possible implementation thereof.

In a sixth aspect, there is provided a computer program, wherein the computer program comprises computer readable codes, and when the computer readable codes are running in an electronic apparatus, a processor in the electronic apparatus executes the method according to the first aspect and any possible implementation thereof.

It should be understood that the above general description and the following detailed description are only exemplary and explanatory, rather than limitative of the disclosure.

### BRIEF DESCRIPTION OF THE DRAWINGS

In order to more clearly explain the technical solutions in the embodiments of the disclosure or the background, the following description will be given to the drawings that need to be used in the embodiments of the disclosure or the background.

The drawings herein are incorporated into and constitute a part of the specification, which illustrate embodiments in accordance with the disclosure and together with the specification are used to explain the technical solutions of the disclosure.

FIG. 1 is a flow diagram of a neural network searching method according to an embodiment of the disclosure;

FIG. 2 is a flow diagram of another neural network searching method according to an embodiment of the disclosure;

FIG. 3a is a diagram of an overall structure of a neural network in a search space according to an embodiment of the disclosure;

FIG. 3b is a diagram of a connection relationship between neural cells in a neural network layer according to an embodiment of the disclosure;

FIG. 3c is a structural diagram of neural cells within a neural layer according to an embodiment of the disclosure;

FIG. 3d is a structural diagram of a node within neural cells according to an embodiment of the disclosure;

FIG. 4a is a diagram of adjustment of a structure of a neural network according to an embodiment of the disclosure;

FIG. 4b is a diagram of another adjustment of a structure of a neural network according to an embodiment of the disclosure;

FIG. 5 is a flow diagram of yet another neural network searching method according to an embodiment of the disclosure;

FIG. 6 is a structural diagram of a neural network searching device according to an embodiment of the disclosure; and

FIG. 7 is a diagram of a hardware structure of a neural network searching device according to an embodiment of the disclosure.

### DETAILED DESCRIPTION

In order to make those in the technical field better understand the disclosed solution, the technical solution in the embodiments of the disclosure will be clearly and completely described below with reference to the drawings in the embodiments of the disclosure. Obviously, the described embodiments are only part of the embodiments of the disclosure, not all of the embodiments. Based on the embodiments in the disclosure, all other embodiments obtained by those of ordinary skill in the art without creative labor are within the scope of protection of the disclosure.

The terms “first”, “second” and the like in the specification and claims of the disclosure and the above drawings are used to distinguish different objects but not used to describe a specific order. Further, the terms “comprise” and “have” and any variations thereof are intended to cover non-exclusive inclusion. For example, a process, method, system, product or device comprising a series of steps or units is not limited to the listed steps or units, but optionally comprises steps or units not listed, or optionally comprises other steps or units inherent to the process, method, product or device.

Reference to an “embodiment” herein means that a particular feature, structure or characteristic described in connection with the embodiment may be included in at least one embodiment of the disclosure. The appearance of this phrase in various places in the specification does not necessarily mean the same embodiment, nor is it an independent or alternative embodiment mutually exclusive with other embodiments. Those skilled in the art understand explicitly and implicitly that the embodiments described herein can be combined with other embodiments.

Because the accuracies of neural networks obtained from training different neural network structures are different in image processing (such as image classification), it is necessary to determine the structures of neural networks with good performance for image processing before the image processing. The better the performance of the structure of the neural network, the higher the accuracy characterizing an image processing with the neural network obtained by training the structure of the neural network.

Neural network search means that the structures of neural networks with good performance in the neural network library can be determined from a large amount of training on neural networks with different structures in the neural network library to be searched, and then target neural networks can be obtained from the neural network library, which can be used for image processing later.

The above-mentioned “good performance” and “good performance” which will appear many times in the following refer to the several ones with the best performance among different neural network structures. The specific number of “several” here can be adjusted as needed. For example, four out of ten different neural network structures with the best performance are called the neural network structures with good performance, and the four neural network structures with the best performance in the ten different neural network structures are a, b, c and d, so a, b, c and d are the neural network structures with good performance.

The phrase “poor performance” will appear many times in the following. “Poor performance” refers to the several ones with the poorest performance among different neural network structures. The specific number of “several” here can be adjusted as needed. For example, three of ten different neural network structures with the poorest performance are called the neural network structures with poor performance, and the three neural network structures with the poorest performance in the ten different neural network structures are e, f and g, so e, f and g are the neural network structures with poor performance.

The embodiments of the disclosure will be described below with reference to the drawings of the embodiments in the disclosure.

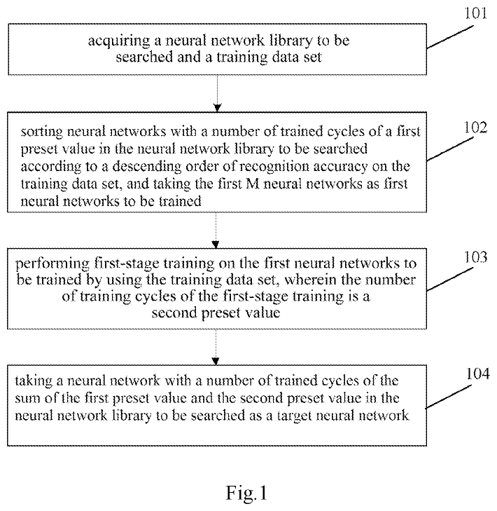

Please refer to FIG. 1. FIG. 1 is a flow diagram of a neural network searching method according to Embodiment 1 of the disclosure.

101: acquiring a neural network library to be searched and a training data set.

In the embodiment of the disclosure, the neural network library to be searched includes a plurality of neural networks to be searched, wherein the neural networks to be searched can be stored in a terminal (such as a computer) executing the embodiment of the disclosure; the neural networks to be searched can also be obtained from a storage medium connected with the terminal; the neural networks to be searched can also be obtained in a randomly generated manner; and the neural networks to be searched can also be obtained through manual design. The disclosure does not limit the way to obtain the neural networks to be searched.

In the embodiment of the disclosure, the training data set may be an image set, and optionally, the image set may be an image set for training neural networks for image classification. The training data set can be stored in a terminal (such as a computer), or obtained from a storage medium connected with the terminal, or acquired by the terminal from the Internet.

102: sorting neural networks with a number of trained cycles of a first preset value in the neural network library to be searched according to a descending order of recognition accuracy on the training data set, and taking the first M neural networks as first neural networks to be trained.

In the embodiment of the disclosure, the recognition accuracy may be the accuracy of a classification result on the training data set. The first preset value is a positive integer, and optionally, the first preset value can be 40. M can be any positive integer. It should be understood that since the number of neural networks in the neural network library to be searched is given, M can also be determined by a preset ratio. For example, the number of neural networks in the neural network library to be searched is 100, and the preset ratio is 50%, that is, the neural networks with the accuracy ranking top 50% are regarded as the first neural networks to be trained; that is, the first 50 neural networks after sorting are regarded as the first neural networks to be trained.

103: performing first-stage training on the first neural networks to be trained by using the training data set, wherein the number of training cycles of the first-stage training is a second preset value.

In the embodiment of the disclosure, the number of training cycles of the first-stage training can be the second preset value, and optionally, the second preset value is 20. By performing the first-stage training on the first neural networks to be trained, the recognition accuracy on the training data set by the first neural networks to be trained can be further improved, and the performance of the network structures of the first neural networks to be trained can be better reflected.

When searching neural networks from the neural network library, it is necessary to train the neural networks to evaluate the performance of the neural network structures. Finally, neural networks with good performance can be selected according to evaluation results. At the same time, the more training times, the more accurate the evaluation of neural network performance is. Because there are a large number of neural networks in the neural network library to be searched, it takes a lot of computing resources and time to evaluate the structural performance of neural networks by training each neural network in the neural network library to be searched.

Therefore, the embodiment of the disclosure adopts the searching strategy of “reducing computing resources and searching time spent on neural networks with poor performance”, which may include: determining neural networks with high accuracy (i.e., neural networks with good performance) from the neural network library to be searched through 102, and performing first-stage training on the neural networks with good performance through 103, thus reducing the computing resources and training time spent on neural networks with poor performance. In this way, the computing resources spent on searching by the neural networks from the neural network library to be searched can be reduced, and the search time can be shortened.

104: taking a neural network with a number of trained cycles of the sum of the first preset value and the second preset value in the neural network library to be searched as a target neural network.

As mentioned above, the number of trained cycles of the first neural networks to be trained is the first preset value, and the number of training cycles of the first-stage training is the second preset value, so the number of trained cycles of the neural networks been subjected to the first-stage training is the sum of the first preset value and the second preset value.

In the embodiment of the disclosure, the target neural network is the neural network obtained by searching, and neural networks with the same structure as the target neural network can be trained later, so that the trained neural networks can be used for image processing (such as image classification).

Optionally, because there may be multiple neural networks with a number of trained cycles of the sum of the first preset value and the second preset value, and the performances of various neural networks are different, among the neural networks with a number of trained cycles of the sum of the first preset value and the second preset value, several neural networks ranked as of the best performance can be selected as target neural networks; for example, among the neural networks with a number of trained cycles of the sum of the first preset value and the second preset value, the first 10 neural networks according to a ranking on performance can be selected as target neural networks.

In this embodiment, by performing first-stage training on the first neural networks to be trained, the neural networks in the neural network library to be searched are trained by stages, that is, only neural networks with good performance after a previous training stage enter the next training stage, thus reducing the computing resources and time spent on the search process.

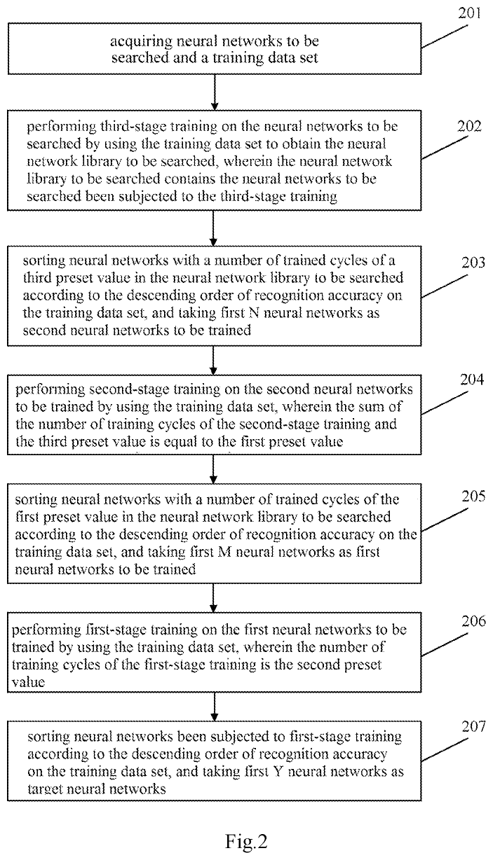

Please refer to FIG. 2. FIG. 2 is a flow diagram of another neural network searching method according to an embodiment of the disclosure.

201: acquiring neural networks to be searched and a training data set.

The neural networks to be searched can be stored in a terminal (such as a computer) executing the embodiment of the disclosure; the neural networks to be searched can also be obtained from a storage medium connected with the terminal; the neural networks to be searched can also be obtained in a randomly generated manner; and the neural networks to be searched can also be obtained through manual design. The disclosure does not limit the way to obtain the neural networks to be searched.

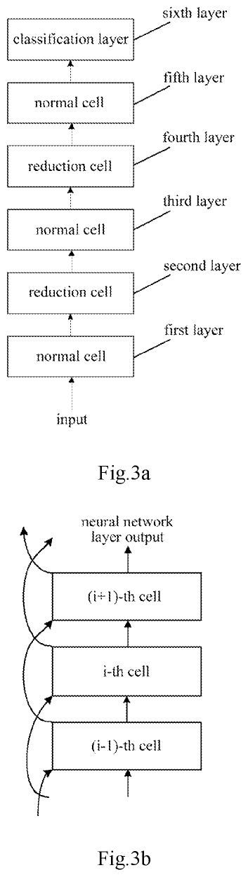

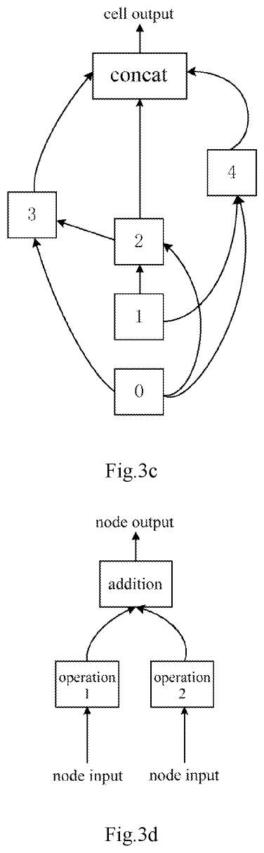

In a possible implementation, a network architecture based on a neural network search space can randomly generate the neural networks to be searched, and optionally, the neural networks to be searched are neural networks for image classification. The search space can be seen in FIG. 3a-3d. FIG. 3a is a diagram of an overall structure of neural networks in the search space. As shown in FIG. 3a, each neural network in the search space includes three normal cells, two reduction cells and one classification cells, and these six neural network layers are connected in series, that is, output of the previous layer is the input of the next layer. Taking an input image as an example, after the processing by the normal cells, the size of the image does not change, but after the processing by the reduction cells, the size of the image will be reduced by half. For example, the size of the input image is 32*32. After being processed by the first normal cell, an output image is 32*32 in size, which will be used as the input of the second reduction cell. After being processed by the second input layer, an output image is 16*16 in size.

FIG. 3b is a diagram of a connection relationship among neural cells in a neural network layer. As shown in FIG. 3b, inputs of an (i+1)-th neural cell in each neural network layer are the outputs of an i-th neural cell and an (i−1)-th neural cell, where i is a positive integer greater than or equal to 2.

FIG. 3c is a structural diagram of the neural cells in FIG. 3b. As shown in FIG. 3c, each neural cell contains five nodes, and each node contains corresponding operations internally, wherein node 0 and node 1 are input nodes, and node 0 is the output of the (i−1)-th neural cell. Node 1 is the output of the i-th neural cell, the inputs of node 2 are the outputs of nodes 0 and 1, and the inputs of node 3 can be the outputs of any two of nodes 0, 1 and 2; that is to say, two of the output of node 0, the output of node 1 and the output of node 2 are randomly selected as the inputs of node 3. The inputs of node 4 can be the outputs of any two of nodes 0, 1, 2 and 3, that is, two of the output of node 0, the output of node 1, the output of node 2 and the output of node 3 are randomly selected as the inputs of node 4. Finally, the outputs of neural cells are obtained from a concat of the outputs of nodes 2, 3 and 4.

FIG. 3d is a structural diagram of nodes within neural cells. As shown in FIG. 3d, two inputs of each node are input to an operation 1 and an operation 2 respectively, wherein each of the operation 1 and the operation 2 can be any one of convolution, pooling and mapping, that is to say, each of the operation 1 and the operation 2 in each node can be of one operation randomly selected from convolution, pooling and mapping. Finally, the outputs of the operation 1 and the operation 2 are added to obtain the output of the node.

It can be seen that by randomly determining the connection relationship among nodes in each neural cell and randomly generating the operations in each node, multiple neural networks to be searched with different network structures can be randomly generated.

It should be understood that the search space in the above implementation is only an example, and should not limit the embodiments of the disclosure, that is, the embodiments of the disclosure can also randomly generate neural networks to be searched based on other search spaces.

Refer to 101 for the way to obtain the training data set, which will not be repeated here.

202: performing third-stage training on the neural networks to be searched by using the training data set to obtain the neural network library to be searched, wherein the neural network library to be searched contains the neural networks to be searched been subjected to the third-stage training.

After the neural networks to be searched are obtained, the training data set can be used to conduct the third-stage training on the neural networks to be searched, and then the neural networks to be searched been subjected to the third-stage training can be added to the neural network library to be searched. The number of training cycles in the third-stage training is a third preset value, which is a positive integer, and optionally, the third preset value is 20.

Optionally, in order to obtain more neural network structures with good performance through searching, a predetermined number of neural networks can be randomly selected from the neural networks in the neural network library to be searched; the selected neural networks can be evolved, and the evolved neural networks can be added to the neural network library to be searched. The higher the recognition accuracy of the training data set by the neural network to be searched, the better the performance of the neural network is, that is, the better the structure of the neural network is. Thus, the probability that a neural network with better performance is evolved from a neural network with good performance is higher than the probability that the neural network with better performance is evolved from a neural network with poor performance. Therefore, the higher the recognition accuracy of the training data set by the neural network to be searched, the greater the probability of the neural network being selected. The evolution of the neural network can be realized by any one of the following and a combination thereof: adjusting the structure of the neural network and changing the parameters of the neural network.

In a possible implementation, R evolved neural networks can be added to the neural network library to be searched by steps of: duplicating R neural networks in the neural network library to be searched; evolving the R duplicated neural networks by modifying the structures of the R duplicated neural networks, to obtain R neural networks to be trained; performing third-stage training on the R neural networks to be trained by using the training data set to obtain the R evolved neural networks, wherein the number of training cycles of the third-stage training is the third preset value; and adding the R evolved neural networks to the neural network library to be searched.

For example, three neural networks (A, B, and C) are randomly selected from the neural network library to be searched; by adjusting the structures of these three neural networks, three evolved neural networks (D, E, and F) are obtained, and the three evolved neural networks are added to the neural network library to be searched. It should be understood that at this point, the neural network library to be searched contains six neural networks: A, B, C, D, E, and F.

The above-mentioned modification of the structures of the R duplicated neural networks can be realized by changing the inputs of the neural cells of the R duplicated neural networks, or by changing the operations of the neural cells of the R duplicated neural networks, or by changing both the neural cells of the R duplicated neural networks and the operations in the nodes of the neural cells of the R duplicated neural networks.

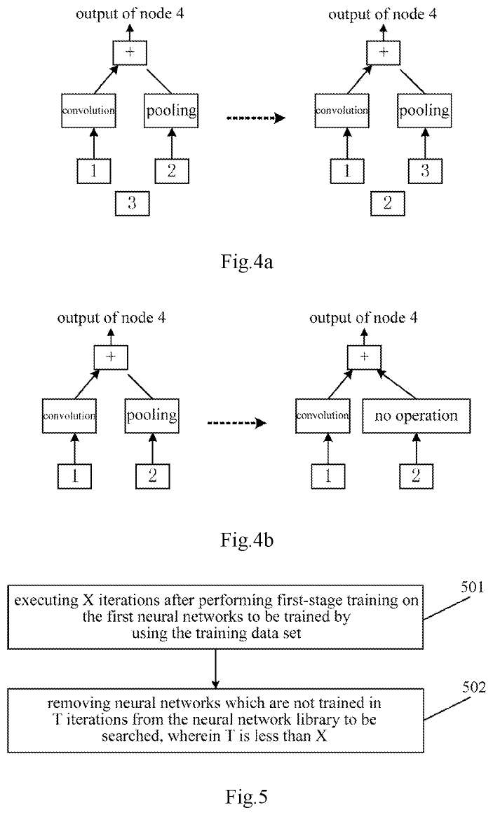

Please refer to FIG. 4a. FIG. 4a is a diagram of adjusting the structure of a neural network by changing the input of nodes in neural cells. As shown in FIG. 4a, before adjusting the structure of the neural network, the inputs of node 4 are the outputs of nodes 1 and 2, and by adjusting the inputs of node 4 to the outputs of nodes 1 and 3, the structure of the neural network can be adjusted, and then the neural network can be evolved.

Please refer to FIG. 4b. FIG. 4b is a diagram of adjustment of the structure of a neural network by changing the operations in the nodes of neural cells of the neural network. As shown in FIG. 4b, node 4 contains an operation 1 (convolution) and an operation 2 (pooling). By setting the operation 2 as doing nothing, the structure of the neural network can be adjusted, and then the neural network can be evolved.

203: sorting neural networks with a number of trained cycles of a third preset value in the neural network library to be searched according to the descending order of recognition accuracy on the training data set, and taking first N neural networks as second neural networks to be trained.

In order to better evaluate the performance of neural networks, it is necessary to continue to train the neural networks in the neural network library to be searched after the third-stage training (that is, the number of trained cycles is the third preset value). Since the purpose of neural network search is to determine neural network structures with good performance from the neural network library to be searched, the embodiment of the disclosure will carry out subsequent trainings on the neural networks with good performance after the third-stage training, thus reducing the computing resources spent on the subsequent search process and shortening the time spent on the search process.

As mentioned above, after obtaining the neural network library to be searched, R evolved neural networks can be added to the neural network library to be searched, and all the R evolved neural networks have been subjected to third-stage training; that is to say, the number of trained cycles of the R evolved neural networks is the third preset value. In addition, before adding the R evolved neural networks to the neural network library to be searched, there are neural networks with a number of trained cycles of the third preset value in the neural network library to be searched. Therefore, neural networks with a number of trained cycles of the third preset value in the neural network library to be searched and the R evolved neural networks are sorted according to the descending order of recognition accuracy on the training data set, and the first N neural networks are regarded as second neural networks to be trained.

In the embodiment of the disclosure, N can be any positive integer. It should be understood that since the number of neural networks in the neural network library to be searched is given, N can also be determined by a preset ratio. For example, the number of neural networks in the neural network library to be searched is 100, and the preset ratio is 50%, that is, the neural networks with the accuracy ranking top 50% are regarded as the second neural networks to be trained, that is, the first 50 neural networks after sorting are regarded as the second neural networks to be trained.

It should be pointed out that letters such as R, M, and Y will appear in the following, but will not be described in detail since they have the same meanings as N.

204: performing second-stage training on the second neural networks to be trained by using the training data set, wherein the sum of the number of training cycles of the second-stage training and the third preset value is equal to the first preset value.

As mentioned above, the number of trained cycles of the second neural networks to be trained is the third preset value, and neural networks with a number of trained cycles of the first preset value can be obtained by conducting second-stage training on the second neural networks to be trained; that is, the sum of the number of training cycles in the second-stage training and the third preset value is equal to the first preset value. For example, if the first preset value is 40 and the third preset value is 20, the number of training cycles in the second-stage training is 20.

Training the neural networks does not change the structures of the neural networks, but improves the recognition accuracy by the neural networks on the training data set. Therefore, the performance of the neural networks obtained by using the training data set to conduct second-stage training on the second neural networks to be trained can reflect the performance of the structures of the second neural networks to be trained more accurately, improving the search accuracy.

205: sorting neural networks with a number of trained cycles of the first preset value in the neural network library to be searched according to the descending order of recognition accuracy on the training data set, and taking first M neural networks as first neural networks to be trained.

As mentioned above, the more training cycles for neural networks, the more accurate the evaluation on neural network performance is, and the higher the search accuracy is. Therefore, in the embodiment of the disclosure, the target number of training cycles for neural network search is set as the sum of the first preset value and the second preset value, that is, the maximum number of trained cycles of the neural networks in the neural network library to be searched is the sum of the first preset value and the second preset value, and the neural networks with a number of trained cycles meeting the sum of the first preset value and the second preset value can be regarded as target neural networks.

After the processing of 202 to 204, the number of trained cycles of some neural networks in the neural network library to be searched is the first preset value, so it is necessary to continue to train the neural networks with a number of trained cycles being a sum of the first preset value. The search continues by using the strategy of “reducing computing resources and search time spent on neural networks with poor performance”, neural networks of a number of trained cycles being the first preset value in the neural network library to be searched are sorted according to the descending order of recognition accuracy on the training data set, and the first M neural networks are regarded as first neural networks to be trained. Optionally, M and N are equal.

206: performing first-stage training on the first neural networks to be trained by using the training data set, wherein the number of training cycles of the first-stage training is the second preset value.

In the embodiment of the disclosure, the number of training cycles of the first-stage training is the second preset value. The number of trained cycles of the neural networks obtained by conducting first-stage training on the first neural networks to be trained by using the training data set can reach the target number of training cycles (i.e. the sum of the first preset value and the second preset value).

207: sorting neural networks been subjected to first-stage training according to the descending order of recognition accuracy on the training data set, and taking first Y neural networks as target neural networks.

After the processing of 201 to 206, the number of trained cycles of some neural networks in the neural network library to be searched has reached the target number of training cycles, that is to say, this part of neural networks has completed the training process of neural network search.

Obviously, because there may be multiple neural networks with a number of trained cycles of the sum of the first preset value and the second preset value, and the performances of various neural networks are different, several neural networks ranked as of the best performance among the neural networks with a number of trained cycles of the sum of the first preset value and the second preset value can be selected as target neural networks, that is, the neural networks with a number of trained cycles of the sum of the first preset value and the second preset value can be sorted according to the descending order of recognition accuracy on the training data set, and the first Y neural networks are regarded as target neural networks.

In this embodiment, the target neural networks are obtained from the neural networks to be searched by sequentially carrying out the third-stage training, the second-stage training and the first-stage training on the neural networks to be searched. By conducting the second-stage training on the neural networks with good performance after the third-stage training and conducting the first-stage training on the neural networks with good performance after the second-stage training, computing resources and time spent on the search process can be greatly reduced. Besides, the search effect can be improved by adding the evolved neural networks to the neural network library to be searched.

Embodiment 2 illustrates an implementation process from randomly generating the neural networks to be searched to obtaining the target neural networks, that is, the randomly generated neural networks to be searched are sequentially subjected to the third-stage training, the second-stage training and the first-stage training to obtain the target neural networks. In practical application, more training is often needed to further improve the search accuracy.

Please refer to FIG. 5. FIG. 5 is a flow chart of another neural network searching method according to Embodiment 3 of the disclosure.

501: executing X iterations after performing first-stage training on the first neural networks to be trained by using the training data set.

In the embodiment of the disclosure, one iteration sequentially includes steps of: adding S evolved neural networks to the neural network library to be searched, wherein the evolved neural networks are obtained by evolving the neural networks in the neural network library to be searched, and S is equal to R; sorting neural networks with a number of trained cycles of the third preset value in the neural network library to be searched and the S evolved neural networks according to the descending order of recognition accuracy on the training data set, and taking the first N neural networks as third neural networks to be trained; sorting neural networks with a number of trained cycles of the first preset value in the neural network library to be searched according to the descending order of recognition accuracy on the training data set, and determining the first M neural networks as fourth neural networks to be trained; and performing the second-stage training on the third neural networks to be trained by using the training data set, and performing the first-stage training on the fourth neural networks to be trained by using the training data set.

The above X iterations are executed after 206 in Embodiment 2, and each iteration includes the first-stage training. In other words, each iteration will generate neural networks of a number of trained cycles being the sum of the first preset value and the second preset value, that is, neural networks of a number of trained cycles being the target number of trained cycles.

It should be understood that if the number of trained cycles of the neural networks in the neural network library to be searched reaches the target number of training cycles, the neural networks will no longer be trained. In addition, during each iteration, S evolved neural networks will be added to the neural network library to be searched (see the process of obtaining R evolved neural networks in 202 for details), and the third neural networks to be trained are subjected to the second-stage training in each iteration. Therefore, after each iteration, the numbers of neural networks in the neural network library with numbers of trained cycles respectively being the first preset value, the third preset value and the target value will all change.

For example, assume that 202 is a first iteration, 203-204 is a second iteration, 205-206 is a third iteration, and the X iterations to be executed in 501 are a fourth iteration, a fifth iteration, . . . , and an (X+3)-th iteration.

It should be pointed out that 205-206 only illustrate the first-stage training of neural networks with good performance and the number of trained cycles being the first preset value in the third iteration. Optionally, the third iteration also includes the processes of sorting neural networks of a number of trained cycles of the third preset value in the neural network library to be searched according to the descending order of recognition accuracy on the training data set, and conducting the second-stage training on the first N neural networks.

Assuming that the number of randomly generated neural networks to be searched is 32, and the first preset value, the second preset value and the third preset value are all 20, N=8, M=4, R=S=16, the numbers of neural networks in the neural network library to be searched with numbers of trained cycles being 20, 40 and 60 respectively before each iteration can be seen in Table 1 below.

TABLE 1

| | | | | Number of |
|---|---|---|---|---|
| | | Number of neural | Number of neural | neural networks |
| | Number of neural | networks with a | networks with a | in the neural |
| Iteration | networks with a number | number of trained | number of trained | network library |
| times | of trained cycles of 20 | cycles of 40 | cycles of 60 | to be searched |
| 1 | 32 | 0 | 0 | 32 |
| 2 | 32 + 16 − 8 | 8 | 0 | 32 + 16 |
| 3 | 32 + 16 − 8 + 16 − 8 | 8 + 8 − 4 | 4 | 32 + 16 + 16 |
| 4 | 32 + 16 − 8 + 16 − 8 + 16 − 8 | 8 + 8 − 4 + 8 − 4 | 4 + 4 | 32 + 16 + 16 + 16 |
| . . . | . . . | . . . | . . . | . . . |
| X + 3 | 32 + (X + 2) * (16 − 8) | 8 + (X + l) * (8 − 4) | 4 + 4X | 32 + 16 (X + 2) |

As shown in Table 1, starting from the third iteration, each subsequent iteration will generate a new neural network with a number of trained cycles of 60 (i.e., a neural network with a number of trained cycles meeting the target number of training cycles).

It should be understood that the data in the above examples are exemplary only, and do not limit the disclosure.

502: removing neural networks which are not trained in T iterations from the neural network library to be searched, where T is less than X.

The purpose of this embodiment is to find the neural network structures with good performance from the neural network library to be searched, that is to say, this embodiment solves an optimization problem. Like the problem of local optimization in other optimization methods, there is also a problem of local optimization in the process of finding the neural network structures with good performance from the neural network library to be searched by the methods of Embodiment 1, Embodiment 2 and 501.

As described in 202, the higher the recognition accuracy on the training data set by the neural networks to be searched (hereinafter, these neural networks to be searched are called neural networks to be searched with good performance), the greater the probability that the neural networks to be searched are selected for evolution. It should be understood that after each iteration, neural networks with good performance will be selected for evolution from the neural network library to be searched, so after each iteration, neural networks with good performance that are not within top sorting results will have a great probability to be evolved, that is, in the neural network library to be searched, the number of neural networks obtained by evolving neural networks to be searched with good performance besides the neural networks to be searched with the best performance (i.e., global optimum) may be large, which may cause the terminal (here refer to the device implementing the embodiment of the disclosure) to “focus” on searching for the evolved neural networks in the subsequent search process, thereby reducing the probability of obtaining neural networks with good performance and reducing the search effect.

In order to solve the above-mentioned local optimization problem, this embodiment removes neural networks which are not trained in T iterations from the neural network library to be searched, so as to reduce the influence of the above-mentioned local optimization problem on the search effect, and further improve the search effect, where T is a positive integer and T is less than X.

For example, if T=10, a neural network G in the neural network library to be searched is not trained in the next 10 iterations after being trained in the 4th iteration (i.e., from the 5th iteration to the 14th iteration, the neural network G is not trained at all), then the neural network G will be removed from the neural network library to be searched after the 14th iteration.

Optionally, if 202 is the first iteration, 203-204 is the second iteration, and 205-206 is the third iteration, see the following example: assuming T=10, a neural network H in the neural network library to be searched is not trained in the next 10 iterations after being trained in the first iteration (that is, from the second iteration to the 11th iteration, the neural network is not trained at all), then the neural network H will be removed from the neural network library to be searched after the 11th iteration.

In another possible implementation, assuming T=2, a neural network K in the neural network library to be searched is not trained in the next two iterations after being trained in the first iteration (i.e., from the second iteration to the third iteration, the neural network k is not trained at all), then the neural network K is removed from the neural network library to be searched after the third iteration.

In this embodiment, the neural networks that have not been trained for a long time (i.e., the neural networks that have not been trained in T iterations) in the neural network library to be searched are removed from the neural network library to reduce the negative influence of the local optimization problem on the search effect in the search process.

It can be understood by those skilled in the art that in the above method of the specific embodiment, the writing order of each step does not mean a strict execution order or constitute any limitation on the implementation process, but the specific execution order of each step should be determined by its function and possible internal logic.

The method of the embodiment of the disclosure is described in detail above, and the device of the embodiment of the disclosure is provided below.

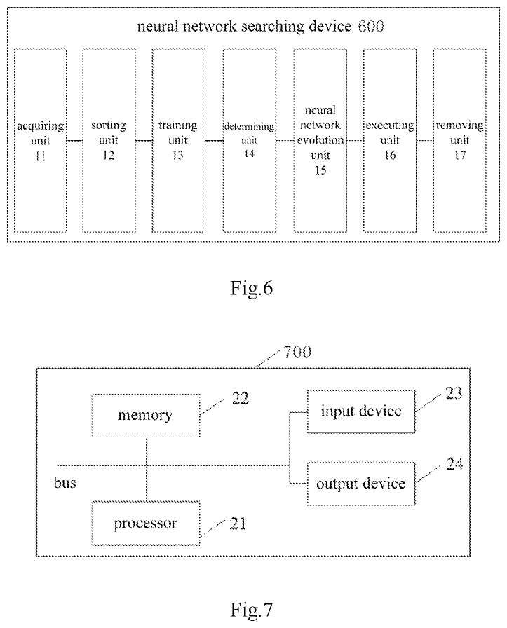

Please refer to FIG. 6. FIG. 6 is a structural diagram of a neural network searching device according to an embodiment of the disclosure. The neural network searching device 600 includes an acquiring unit 11, a sorting unit 12, a training unit 13, a determining unit 14, a neural network evolution unit 15, an executing unit 16 and a removing unit 17, wherein

the acquiring unit 11 is used for acquiring a neural network library to be searched and a training data set;

the sorting unit 12 is used for sorting neural networks with a number of trained cycles of a first preset value in the neural network library to be searched according to a descending order of recognition accuracy on the training data set, and taking first M neural networks as a first neural network set to be trained;

a training unit 13 is used for performing first-stage training on the first neural network set to be trained by using the training data set, wherein the number of training cycles of the first-stage training is a second preset value; and

a determining unit 14 is used for taking a neural network with a number of trained cycles of the sum of the first preset value and the second preset value in the neural network library to be searched as a target neural network.

The sorting unit 12 is further used to: before sorting neural networks with a number of trained cycles of a first preset value in the neural network library to be searched according to a descending order of recognition accuracy on the training data set and taking first M neural networks as a first neural network set to be trained, sort neural networks with a number of trained cycles of a third preset value in the neural network library to be searched according to the descending order of recognition accuracy on the training data set, and taking first N neural networks as a second neural network set to be trained, and the training unit is further configured to perform second-stage training on the second neural network set to be trained by using the training data set, wherein the sum of the number of training cycles of the second-stage training and the third preset value is equal to the first preset value.

In a possible implementation, the neural network searching device 600 further includes a neural network evolution unit 15 configured to: before sorting neural networks with a number of trained cycles of a third preset value in the neural network library to be searched according to the descending order of recognition accuracy on the training data set and taking first N neural networks as a second neural network set to be trained, add R evolved neural networks to the neural network library to be searched, wherein the evolved neural networks are obtained by evolving the neural networks in the neural network library to be searched; and the sorting unit 12 is specifically configured to: sort neural networks with a number of trained cycles of the third preset value in the neural network library to be searched and the R evolved neural networks according to the descending order of recognition accuracy on the training data set, and take the first N neural networks as the second neural network set to be trained.

In another possible implementation, the neural network searching device 600 further includes an executing unit 16 configured to: after performing first-stage training on the first neural network set to be trained by using the training data set, execute X iterations, the iterations including: adding S evolved neural networks to the neural network library to be searched, wherein the evolved neural networks are obtained by evolving the neural networks in the neural network library to be searched, and S is equal to R; sorting neural networks with a number of trained cycles of the third preset value in the neural network library to be searched and the S evolved neural networks according to the descending order of recognition accuracy on the training data set, and taking the first N neural networks as a third neural network set to be trained; sorting neural networks with a number of trained cycles of the first preset value in the neural network library to be searched according to the descending order of recognition accuracy on the training data set, and taking first M neural networks as a fourth neural network set to be trained; performing the second-stage training on the third neural network set to be trained by using the training data set, and performing the first-stage training on the fourth neural network set to be trained by using the training data set; and the neural network searching device 600 further includes: a removing unit 17, for removing neural networks which are not trained in T iterations from the neural network library to be searched, where T is less than X.

In yet another possible implementation, the neural network evolution unit 15 is specifically used to: duplicate R neural networks in the neural network library to be searched to obtain R duplicated neural networks; evolve the R duplicated neural networks by modifying structures of the R duplicated neural networks to obtain R neural networks to be trained; perform third-stage training on the R neural networks to be trained by using the training data set to obtain the R evolved neural networks, wherein the number of training cycles of the third-stage training is the third preset value; and add the R evolved neural networks to the neural network library to be searched.

In yet another possible implementation, the neural networks in the neural network library to be searched are used for image classification.

In yet another possible implementation, the neural network in the neural network library to be searched includes a normal cell, a reduction cell and a classification cell; the normal cell, the reduction cell and the classification cell are sequentially connected in series; the normal cell is used for extracting a feature from image input into the normal cell; the reduction cell is used for extracting a feature from image input into the reduction cell and reducing size of the image input into the reduction cell; the classification cell is used for obtaining a classification result of the image input into the neural networks of the neural network library to be searched according to the feature output by the reduction cell; each of the normal cell and the reduction cell includes a plurality of neural cells; neural cells in the plurality of neural cells are sequentially connected in series, and input of an (i+1)-th neural cell includes output of an i-th neural cell and output of an (i−1)-th neural cell; the (i+1)th neural cell, the i-th neural cell and the (i−1)-th neural cell belong to the plurality of neural cells, where i is a positive integer greater than 1; a neural cell includes j nodes; input of a k-th node is output of any two of the k−1 nodes before the k-th node, where k is a positive integer greater than 2, and k is less than or equal to j; output of the neural cell is resulted from a concat of output of a j-th node and output of a (j−1)-th node; the node includes at least two operations; input of the operation is the input of the node; and the operation is any one of convolution, pooling and mapping.

In yet another possible implementation, the neural network evolution unit is in particular configured to: modify the structures of the R duplicated neural networks by changing input to neural cells of the R duplicated neural networks; and/or modify the structures of the R duplicated neural networks by changing operations in nodes of the neural cells of the R duplicated neural networks.

In yet another possible implementation, the acquiring unit 11 is in particular configured to: acquire neural networks to be searched; and perform the third-stage training on the neural networks to be searched by using the training data set to obtain the neural network library to be searched, wherein the neural network library to be searched contains the neural networks to be searched been subjected to the third-stage training.

In yet another possible implementation, the determining unit 14 is in particular configured to: sort neural networks with a number of trained cycles of the sum of the first preset value and the second preset value in the neural network library to be searched according to the descending order of recognition accuracy on the training data set, and take first Y neural networks as the target neural networks.

In some embodiments, the functions or modules of the device provided by the embodiment of the disclosure can be used to execute the method described in the above method embodiment. Please refer to the description of the above method embodiment for specific implementation, which is not repeated here for brevity.

The embodiment of the disclosure also provides a processor for executing the above method.

The embodiment of the disclosure also provides an electronic apparatus, comprising a processor, a transmitting device, an input device, an output device and a memory, the memory being used for storing computer program codes, and the computer program codes comprising computer instructions which, when executed by the processor, cause the electronic apparatus to execute the above method.

The embodiment of the disclosure also provides a computer readable storage medium, the computer readable storage medium stores a computer program, and the computer program includes program instructions which, when executed by a processor of an electronic apparatus, cause the processor to execute the above method. The computer readable storage medium may be a nonvolatile computer readable storage medium or a volatile computer readable storage medium.

The embodiment of the disclosure also provides a computer program, the computer program includes computer readable codes, and when the computer readable codes run in an electronic apparatus, a processor in the electronic apparatus executes the above method.

FIG. 7 is a diagram of a hardware structure of a neural network searching device according to an embodiment of the disclosure. The neural network searching device 700 includes a processor 21, a memory 22, an input device 23 and an output device 24. The processor 21, the memory 22, the input device 23 and the output device 24 are coupled through connectors, which include various interfaces, transmission lines or buses, which is not limited by the embodiment of the disclosure. It should be understood that, in various embodiments of the disclosure, coupling refers to mutual connection in specific ways, including direct connection or indirect connection through other devices, for example, connection through various interfaces, transmission lines or buses.

The processor 21 may be one or more graphics processing units (GPU). If the processor 21 is a GPU, the GPU may be a single-core GPU or a multi-core GPU. Optionally, the processor 21 may be a processor group composed of a plurality of GPUs, and the plurality of processors are coupled through one or more buses. Optionally, the processor may also be other types of processors, etc., which is not limited by the embodiment of the disclosure.

The memory 22 can be used for storing computer program instructions, and various computer program codes including program codes for executing the disclosed solution. Optionally, the memory includes, but is not limited to, random access memory (RAM), read-only memory (ROM), erasable programmable read-only memory (EPROM), or compact disc read-only memory (CD-ROM), which is used for related instructions and data.

The input device 23 is used for inputting data and/or signals, and the output device 24 is used for outputting data and/or signals. The input device 23 and the output device 24 may be independent devices or an integral device.

It can be understood that in the embodiment of the disclosure, the memory 22 can be used to store not only related instructions but also related images, for example, the memory 22 can be used to store the neural networks to be searched obtained by the input device 23, or the target neural networks obtained by the processor 21 through searching, etc. The embodiment of the disclosure does not limit the specific data stored in the memory.

It can be understood that FIG. 7 only shows a simplified design of the neural network searching device. In practical application, the neural network searching device may also include other necessary elements, including but not limited to any number of input/output devices, processors, and memories, and all the neural network searching devices that can realize the embodiments of the disclosure are within the protection scope of the disclosure.

One of ordinary skill in the art can realize that the units and algorithm steps of the examples described in connection with the embodiments disclosed herein can be implemented in electronic hardware, or a combination of computer software and electronic hardware. Whether these functions are implemented in hardware or software depends on the specific application and design constraints of the technical solution. Professionals can use different methods to implement the described functions for each specific application, but such implementation should not be considered beyond the scope of the disclosure.

Those skilled in the art can clearly understand that for convenience and conciseness of description, the specific working processes of the above-described systems, devices and units can be understood with reference to the corresponding processes in the above-described method embodiments and will not be repeated here. It can also be clearly understood by those skilled in the art that each embodiment of the disclosure has its own emphasis. For convenience and conciseness of description, the same or similar parts may not be repeated in different embodiments. Therefore, for the parts that are not described or not described in detail in one embodiment, one can refer to the records of other embodiments.

In the embodiments provided in the disclosure, it should be understood that the disclosed system, device and method may be implemented in other ways. For example, the device embodiments described above are only schematic. For example, the division of the units is only a logic function division. In actual implementation, there may be other division methods, for instance, multiple units or components may be combined or integrated into another system, or some features may be ignored or not executed. In addition, the coupling, direct coupling or communication shown or discussed may be indirect coupling or communication through some interfaces, devices or units, and may be electrical, mechanical or other forms.

The units described as separate components may or may not be physically separated, and the components displayed as units may or may not be physical units, i.e., may be located in one place or may be distributed over multiple network units. Some or all of the units may be selected according to actual needs to achieve the purpose of the present embodiment.

In addition, various functional units in each embodiment of the disclosure may be integrated into one processing unit, or each unit may separately exist physically, or two or more units may be integrated into one unit.

In the above embodiments, the functional units can be implemented in whole or in part by software, hardware, firmware or any combination thereof. When implemented by software, the functional units can be implemented in whole or in part by computer program products. The computer program products include one or more computer instructions. When the computer program instructions are loaded and executed on a computer, the flow or function according to the embodiments of the disclosure is generated in whole or in part. The computer may be a general purpose computer, a special purpose computer, a computer network, or other programmable devices. The computer instructions may be stored in a computer readable storage medium or transmitted through the computer readable storage medium. The computer instructions may be transmitted from one website, computer, server or data center to another website, computer, server or data center through wired [such as coaxial cable, optical fiber, digital subscriber line (DSL)] or wireless (such as infrared, wireless, and microwave) methods. The computer readable storage medium may be any available medium that can be accessed by a computer, or a data storage device such as server and data center that contains one or more available media integrations. The available medium may be magnetic medium (e.g., floppy disk, hard disk, magnetic tape), optical medium [e.g., digital versatile disc (DVD)], or semiconductor medium [e.g., solid state disk (SSD)].

Under the condition of not violating logic, different embodiments of the disclosure can be combined with each other. Each embodiment of the disclosure has its own emphasis. For the emphasized descriptions, please refer to the records of other embodiments.

Those of ordinary skill in the art can understand all or part of the flow for implementing the above method embodiments, which can be completed by a computer program instructing related hardware. The computer program can be stored in a computer readable storage medium, and when executed, the computer program can contain the flow of the above method embodiments. The aforementioned storage medium includes read-only memory (ROM), random access memory (RAM), magnetic disk or optical disk, and other media that can store program codes.

What is claimed is:

1. A neural network searching method, wherein the method comprises:
acquiring a neural network library to be searched and a training data set;
sorting neural networks with a number of trained cycles of a first preset value in the neural network library to be searched according to a descending order of recognition accuracy on the training data set to obtain a first neural network sequence set, and taking first M neural networks in the first neural network sequence set as a first neural network set to be trained;
performing first-stage training on the first neural network set to be trained by using the training data set, wherein the number of training cycles of the first-stage training is a second preset value; and
taking a neural network with a number of trained cycles of the sum of the first preset value and the second preset value in the neural network library to be searched as a target neural network.

2. The method according to claim 1, wherein before sorting neural networks with a number of trained cycles of a first preset value in the neural network library to be searched according to a descending order of recognition accuracy on the training data set to obtain a first neural network sequence set and taking first M neural networks in the first neural network sequence set as a first neural network set to be trained, the method further comprises:
sorting neural networks with a number of trained cycles of a third preset value in the neural network library to be searched according to the descending order of recognition accuracy on the training data set to obtain a second neural network sequence set, and taking first N neural networks in the second neural network sequence set as a second neural network set to be trained; and
performing second-stage training on the second neural network set to be trained by using the training data set, wherein the sum of the number of training cycles of the second-stage training and the third preset value is equal to the first preset value.

3. The method according to claim 2, wherein before sorting neural networks with a number of trained cycles of a third preset value in the neural network library to be searched according to the descending order of recognition accuracy on the training data set to obtain a second neural network sequence set and taking first N neural networks in the second neural network sequence set as a second neural network set to be trained, the method further comprises:
adding R evolved neural networks to the neural network library to be searched, wherein the evolved neural networks are obtained by evolving the neural networks in the neural network library to be searched; and
sorting neural networks with a number of trained cycles of a third preset value in the neural network library to be searched according to the descending order of recognition accuracy on the training data set to obtain a second neural network sequence set and taking first N neural networks in the second neural network sequence set as a second neural network set to be trained includes:
sorting neural networks with a number of trained cycles of the third preset value in the neural network library to be searched and the R evolved neural networks according to the descending order of recognition accuracy on the training data set to obtain a third neural network sequence set, and taking the first N neural networks in the third neural network sequence set as the second neural network set to be trained.

4. The method according to claim 3, wherein after performing first-stage training on the first neural network set to be trained by using the training data set, the method further comprises executing X iterations, the iterations including:
adding S evolved neural networks to the neural network library to be searched, wherein the evolved neural networks are obtained by evolving the neural networks in the neural network library to be searched, and S is equal to R;
sorting neural networks with a number of trained cycles of the third preset value in the neural network library to be searched and the S evolved neural networks according to the descending order of recognition accuracy on the training data set to obtain a fourth neural network sequence set, and taking the first N neural networks in the fourth neural network sequence set as a third neural network set to be trained; sorting neural networks with a number of trained cycles of the first preset value in the neural network library to be searched according to the descending order of recognition accuracy on the training data set to obtain a fifth neural network sequence set, and taking first M neural networks in the fifth neural network sequence set as a fourth neural network set to be trained;
performing the second-stage training on the third neural network set to be trained by using the training data set, and performing the first-stage training on the fourth neural network set to be trained by using the training data set;
and the method further comprises:
removing neural networks which have not been trained in T iterations from the neural network library to be searched, where T is less than X.

5. The method according to claim 3, wherein adding R evolved neural networks to the neural network library to be searched includes:
duplicating R neural networks in the neural network library to be searched to obtain R duplicated neural networks;
evolving the R duplicated neural networks by modifying structures of the R duplicated neural networks to obtain R neural networks to be trained;
performing third-stage training on the R neural networks to be trained by using the training data set to obtain the R evolved neural networks, wherein the number of training cycles of the third-stage training is the third preset value; and
adding the R evolved neural networks to the neural network library to be searched.

6. The method according to claim 5, wherein the neural networks in the neural network library to be searched are used for image classification.

7. The method according to claim 6, wherein,
the neural network in the neural network library to be searched includes a normal cell, a reduction cell and a classification cell;
the normal cell, the reduction cell and the classification cell are sequentially connected in series; the normal cell extracts a feature from image input into the normal cell; the reduction cell extracts a feature from image input into the reduction cell and reducing size of the image input into the reduction cell; the classification cell obtains a classification result of the image input into the neural networks of the neural network library to be searched according to the feature output by the reduction cell;
each of the normal cell and the reduction cell includes a plurality of neural cells; neural cells in the plurality of neural cells are sequentially connected in series, input of an (i+1)-th neural cell includes output of an i-th neural cell and output of an (i−1)-th neural cell; the (i+1)th neural cell, the i-th neural cell and the (i−1)-th neural cell belong to the plurality of neural cells, where i is a positive integer greater than 1;
the neural cell includes j nodes; input of a k-th node is output of any two of the k−1 nodes before the k-th node, where k is a positive integer greater than 2, and k is less than or equal to j; output of the neural cell is resulted from a concat of output of a j-th node and output of a (j−1)-th node; and
the node includes at least two operations; input of the operation is the input of the node; and the operation is any one of convolution, pooling and mapping.

8. The method according to claim 6, wherein modifying structures of the R duplicated neural networks includes:
modifying the structures of the R duplicated neural networks by changing input to neural cells of the R duplicated neural networks; and/or
modifying the structures of the R duplicated neural networks by changing operations in nodes of the neural cells of the R duplicated neural networks.

9. The method according to claim 5, wherein acquiring a neural network library to be searched includes:
acquiring neural networks to be searched; and
performing the third-stage training on the neural networks to be searched by using the training data set to obtain the neural network library to be searched, wherein the neural network library to be searched containing the neural networks to be searched been subjected to the third-stage training.

10. The method according to claim 1, wherein taking a neural network with a number of trained cycles of the sum of the first preset value and the second preset value in the neural network library to be searched as a target neural network includes:
sorting neural networks with a number of trained cycles of the sum of the first preset value and the second preset value in the neural network library to be searched according to the descending order of recognition accuracy on the training data set to obtain a fifth neural network sequence set, and taking first Y neural networks in the fifth neural network sequence set as the target neural networks.

11. A neural network searching device, wherein the device comprises:
a processor, and
a memory configured to store processor-executable instructions;
wherein the processor is configured to invoke the instructions stored on the memory to:
acquire a neural network library to be searched and a training data set;
sort neural networks with a number of trained cycles of a first preset value in the neural network library to be searched according to a descending order of recognition accuracy on the training data set to obtain a first neural network sequence set, and taking first M neural networks in the first neural network sequence set as a first neural network set to be trained;
perform first-stage training on the first neural network set to be trained by using the training data set, wherein the number of training cycles of the first-stage training is a second preset value; and
take a neural network with a number of trained cycles of the sum of the first preset value and the second preset value in the neural network library to be searched as a target neural network.

12. The device according to claim 11, wherein the processor is further configured to invoke the instructions to:
before sorting neural networks with a number of trained cycles of a first preset value in the neural network library to be searched according to a descending order of recognition accuracy on the training data set to obtain a first neural network sequence set and taking first M neural networks in the first neural network sequence set as a first neural network set to be trained;
sort neural networks with a number of trained cycles of a third preset value in the neural network library to be searched according to the descending order of recognition accuracy on the training data set to obtain a second neural network sequence set, and taking first N neural networks in the second neural network sequence set as a second neural network set to be trained; and
perform second-stage training on the second neural network set to be trained by using the training data set, wherein the sum of the number of training cycles of the second-stage training and the third preset value is equal to the first preset value.

13. The device according to claim 12, wherein the processor is further configured to invoke the instructions to:
before sorting neural networks with a number of trained cycles of a third preset value in the neural network library to be searched according to the descending order of recognition accuracy on the training data set to obtain a second neural network sequence set and taking first N neural networks in the second neural network sequence set as a second neural network set to be trained, add R evolved neural networks to the neural network library to be searched, wherein the evolved neural networks are obtained by evolving the neural networks in the neural network library to be searched;
wherein sorting neural networks with a number of trained cycles of a third preset value in the neural network library to be searched according to the descending order of recognition accuracy on the training data set to obtain a second neural network sequence set and taking first N neural networks in the second neural network sequence set as a second neural network set to be trained includes:
sort neural networks with a number of trained cycles of the third preset value in the neural network library to be searched and the R evolved neural networks according to the descending order of recognition accuracy on the training data set to obtain a third neural network sequence set, and take the first N neural networks in the third neural network sequence set as the second neural network set to be trained.

14. The device according to claim 13, wherein the processor is further configured to invoke the instructions to:
after performing first-stage training on the first neural network set to be trained by using the training data set, execute X iterations, the iterations including:
adding S evolved neural networks to the neural network library to be searched, wherein the evolved neural networks are obtained by evolving the neural networks in the neural network library to be searched, and S is equal to R;
sorting neural networks with a number of trained cycles of the third preset value in the neural network library to be searched and the S evolved neural networks according to the descending order of recognition accuracy on the training data set to obtain a fourth neural network sequence set, and taking the first N neural networks in the fourth neural network sequence set as a third neural network set to be trained; sorting neural networks with a number of trained cycles of the first preset value in the neural network library to be searched according to the descending order of recognition accuracy on the training data set to obtain a fifth neural network sequence set, and taking first M neural networks in the fifth neural network sequence set as a fourth neural network set to be trained;
performing the second-stage training on the third neural network set to be trained by using the training data set, and
performing the first-stage training on the fourth neural network set to be trained by using the training data set; and
the processor is further configured to invoke the instructions to:
remove neural networks which have not been trained in T iterations from the neural network library to be searched, where T is less than X.

15. The device according to claim 13, wherein adding R evolved neural networks to the neural network library to be searched includes:
duplicating R neural networks in the neural network library to be searched to obtain R duplicated neural networks;
evolving the R duplicated neural networks by modifying structures of the R duplicated neural networks to obtain R neural networks to be trained;
performing third-stage training on the R neural networks to be trained by using the training data set to obtain the R evolved neural networks, wherein the number of training cycles of the third-stage training is the third preset value; and
adding the R evolved neural networks to the neural network library to be searched.

16. The device according to claim 15, wherein the neural networks in the neural network library to be searched are used for image classification.

17. The device according to claim 16, wherein,
the neural network in the neural network library to be searched includes a normal cell, a reduction cell and a classification cell;
the normal cell, the reduction cell and the classification cell are sequentially connected in series; the normal cell extracts a feature from image input into the normal cell; the reduction cell i extracts a feature from image input into the reduction cell and reducing size of the image input into the reduction cell; the classification cell obtains a classification result of the image input into the neural networks of the neural network library to be searched according to the feature output by the reduction cell;
each of the normal cell and the reduction cell includes a plurality of neural cells; neural cells in the plurality of neural cells are sequentially connected in series, and input of an (i+1)-th neural cell includes output of an i-th neural cell and output of an (i−1)-th neural cell; the (i+1)th neural cell, the i-th neural cell and the (i−1)-th neural cell belong to the plurality of neural cells, where i is a positive integer greater than 1;
the neural cell includes j nodes; input of a k-th node is output of any two of the k−1 nodes before the k-th node, where k is a positive integer greater than 2, and k is less than or equal to j; output of the neural cell is resulted from a concat of output of a j-th node and output of a (j−1)-th node; and
the node includes at least two operations; input of the operation is the input of the node; and the operation is any one of convolution, pooling and mapping.

18. The device according to claim 16, wherein the processor is further configured to invoke the instructions to:
modify the structures of the R duplicated neural networks by changing input to neural cells of the R duplicated neural networks; and/or
modify the structures of the R duplicated neural networks by changing operations in nodes of the neural cells of the R duplicated neural networks.

19. The device according to claim 15, wherein the processor is further configured to invoke the instructions to:
acquire neural networks to be searched; and
perform the third-stage training on the neural networks to be searched by using the training data set to obtain the neural network library to be searched, wherein the neural network library to be searched containing the neural networks to be searched been subjected to the third-stage training.

20. A non-transitory computer readable storage medium, wherein the computer readable storage medium stores a computer program, and the computer program includes program instructions which, when executed by a processor of an electronic apparatus, cause the processor to:
acquire a neural network library to be searched and a training data set;
sort neural networks with a number of trained cycles of a first preset value in the neural network library to be searched according to a descending order of recognition accuracy on the training data set to obtain a first neural network sequence set, and taking first M neural networks in the first neural network sequence set as a first neural network set to be trained;
perform first-stage training on the first neural network set to be trained by using the training data set, wherein the number of training cycles of the first-stage training is a second preset value; and
take a neural network with a number of trained cycles of the sum of the first preset value and the second preset value in the neural network library to be searched as a target neural network.
